(19) United States
(12) Patent Application Publication
(10) Pub. No.: US 2011/0278300 A1
(43) Pub. Date: Nov. 17, 2011

(54) MOULDED FIBER LID

(75) Inventors: Mangat Rai Sharma, Jevnakar (NO); Donald Victor Breton, North Vassalboro, ME (US)

(73) Assignee: HUHTAMAKI MOLDED FIBER TECHNOLOGY B.V., Franeker (NL)

(21) Appl. No.: 13/131,957

(22) PCT Filed: Jun. 11, 2009
(86) PCT No.: PCT/NL2009/050329

§ 371 Date: Jul. 26, 2011

(30) Foreign Application Priority Data
Dec. 2, 2008 (NL) 2002270

(51) Int. Cl. B65D 45/00; B28B 1/10

(52) U.S. Cl. 220/315; 264/87

(57) ABSTRACT

The invention relates to a lid (1) for placement on a container, said lid comprising a top wall (2), a circumferential wall (3) extending downwardly from said top wall, said circumferential wall ending in a flange (4), said flange comprising a circumferential wall part (5) extending outwardly from said circumferential wall for resting on an upper rim of said container and a circumferential locking wall (6) extending downwardly from said wall part for encircling the upper rim of said container, said locking wall comprising at least two solid notches (7) for snappingly attaching said lid around said upper rim of said container, and wherein said lid is made from hot-pressed moulded fibre material.

### BACKGROUND

The present invention relates to a lid for a food container.

A lid which can be snapped on a food container like a cup or a beaker are well known. Usually, these lids are injection moulded of thermoformed from all sorts of plastic material. A disadvantage if the is that they cause a lot of waste, and sometimes end up as litter in the natural environment. Plastics decompose only very slowly in this natural environment. The plastic litter therefore remains a burden on the environment for a long time. Furthermore, they often require the use of precious sources of raw material.

These lid are used for containers for consumable products, such as food or beverages.

Convenience food and beverage chains typically dispense hot beverages such as coffee, tea or soup, or cold beverages such as carbonated drinks, via disposable containers. These may, for example, be made of low-cost paper, card board or plastics material. Disposable lids for the containers are also frequently provided and can assist in reducing the risk of spillage, or in keeping a beverage hot (or cold) for an extended period of time. These factors are particularly important if a consumer is likely to take a beverage on a journey e.g. by rail, road, air or by foot. Also for ice cream and for instance milkshakes, these disposable containers are often used.

Lids for such disposable containers are generally circular in shape and frequently provided with an annular recess designed for receiving a complementarily shaped rim. Press fitting of the rim into the recess can then be used to provide a good seal until the lid is removed (e.g. when it was desired to drink the beverage or eat the ice cream).

An additional frequently encountered problem is that, in order to keep down costs, walls of the lids are often made of thin material or of plastic material. Furthermore, when made of plastic, these lids tend to lack stiffness.

The closure or lid can be reusable so that it can be used to seal the aperture of a container a plurality of times. Reusable closures are known, for example, from milk or soft drink cartons.

A lid of the present invention can be used for a container to contain any desired substance and is not limited to containing particular foods or beverages. It is however particularly useful in containing hot or cold foods or beverages—e.g. chilled drinks, ice-cream, milk shakes, tea, coffee, hot chocolate, soup, etc. The container can be any desired shape. For example, it may be frustoconical.

In an embodiment, it is a cup.

As described above, food containers with removable lids are well known in the industry. Such containers will typically comprise a container bottom or receptacle having a cavity therein for the storage of a food product. The container receptacle will typically have a sidewall, a bottom wall and an upwardly opening top defined by a peripheral lip. The lid is removably mounted to the receptacle at the open end to selectively close the container opening. The lid may be semi-permanently secured to the receptacle or may be easily removably mounted to the receptacle as for example a friction fit or held in place by a snap lock fit. For some food products, a membrane closure can also be provided for hermetically sealing the container bottom and to provide tamper evidence should the container be opened prior to sale or even after sale. Such containers may be sold as singles or in a multi-pack version. An overwrap may also be provided for the container, particularly those containers which have the lid easily removable, to help prevent tampering and accidental lid removal. Containers with easily removable lids can be used for ice cream, yogurt, margarine, sour cream, dips, sauces and the like. In such case, the container bottom or receptacle is made from a material and by a method compatible with the product to be stored. Examples of such receptacles include a helically wrapped paperboard, a side seamed wrapped construction, a polymeric container made by injection molding, thermoforming or vacuum forming. After use, the container together with the lid is disposed.

Typically, packaging is a low margin product and should produced in a manner that is amenable for high speed production and not result in any appreciable increase in the cost of the container to the food manufacturer. This is even more so for disposable containers. Because packaging equipment is expensive, it is often times been found desirable to manufacture container components at one facility and assemble them at another facility after filling. It is also desired that the final assembly of the filled containers be done with currently existing machinery at the food production plant. This eliminates the need for a new machine at each manufacturing facility and the attendant costs.

US-2006 213916 discloses a moulded fibre container lid having a skirt extending around the perimeter and having an inside surface into which an undercut is made. The lid is designed to fit onto a base container. The lid is wet-pressed from fibre pulp and subsequently dried. This provides relatively thick, rough products. The lid in fact has a thickened circumferential rim in the skirt locking the lid onto a base container. Placement and removal leave room for improvement.

### SUMMARY OF THE INVENTION

The invention aims to improve current disposable food containers.

According to a first aspect of the invention this is realized with a lid for placement on a container, said lid comprising a top wall and a circumferential wall extending downwardly from said top wall, said circumferential wall ending in a flange, said flange comprising a circumferential wall part_extending outwardly from said circumferential wall for resting on an upper rim of said container and a circumferential locking wall extending downwardly from said wall part for encircling the upper rim of said container, said locking wall comprising at least two solid notches for snappingly attaching said lid around said upper rim of said container, and wherein said lid is made from hot-pressed moulded fibre material.

It was found that when providing a container having that shape in combination with that material it proved possible to provide a lid which has many beneficial qualities. It looks attractive. It is cheap and fast to produce. It was found to have a good carbon footprint. It is stiff enough to provide a proper lid which can be pushed onto a container without being damaged. Furthermore, it can be manipulated in an automated environment. And, finally, it was found to be biodegradable. This allows a lid which can have these sometimes contradictory properties. In contrast to plastic lids, it does not harm animals, for instance hedgehogs which tend to roam waste sites near fast food restaurants.

The lid or cover thus includes a notch extending inwardly from the outer periphery of the flange to allow a consumer to easily remove it. The present invention also involves the provision of a process for manufacturing a food container including a lid and container bottom. The container bottom is suitably formed.

In some cases, the container is filled with product, for instance ice cream, at a point of sales, and subsequently the lid is placed on the rim of the container. In such case, the lid should be stiff enough to properly place it on the filled container, and the snap-lock should be fail safe but sure. In fact, the current construction in combination with the used molded fiber technique allows a lid which is extremely stiff and strong.

A further aspect of the lid is that it allows efficient stacking and de-stacking because of its smooth-finish production from fiber pulp.

In an embodiment, the pulp is processed in a molded fiber technology using high grade post industrial fiber qualities. In an embodiment, unprinted scanboard cuttings and/or mixtures with virgin fiber qualities are used. In fact, cellulose fiber material is used which is suitable for direct food contact according to BfR compliance, German recommendation XXXVI for health related evaluation of materials and objects for direct contact compliance with the foodstuffs.

Further embodiments of the lid are disclosed in the dependent claims and in the description of the drawings. For these embodiments, this current description provides advantages.

In an embodiment, said circumferential wall is substantially conical. In a further or alternative embodiment, said circumferential wall is curved inwardly.

In an embodiment, said circumferential wall comprises substantially conical buttresses. These rounded, outward extending parts provide additional strength, on particular when pushing the lid onto a container.

In an embodiment, said flange further comprises a circumferential rim extending outwardly from said locking wall.

In an embodiment, said lid is produced using a smooth moulded fibre moulding process, said process comprising the steps of suction moulding at least one lid producing a wet moulded lid, bringing said wet moulded lid on a vacuum mould and hot-pressing said wet moulded lid.

In an embodiment, said locking wall comprises several, in an embodiment at least four, notches, in an embodiment said notched are solid notched. These notches can be positioned around the circumference. In moulded fiber, it was found that such an embodiment makes it possible to on the one hand produce these lids in mass production, and on the other hand provide a sufficient snap fit to a cup or beaker.

In an embodiment, said notches have a small negative draft angle providing an undercut. In this way, which is not evident in moulded fiber technology as it complicates removal from a mould, it allows the lid to snap onto the rim of a container.

In an embodiment, said notches are circumferentially spaced apart.

In an embodiment, said notches extend about 0.05-0.5 mm from an inner surface of said locking wall, in an embodiment about 0.05-0.15 mm from said inner surface. It was found that these sizes still allow removal from a mould, but also allow sufficiently firm snapping on the rim of a container.

The invention further pertains to a container comprising a container part having a bottom wall and a circumferential sidewall connected to said bottom wall having a rim, and the lid described above snap fitted on said rim.

In an embodiment, the lids were made using the smooth molded fiber technology, but it is possible to manufacture lids using the rough molded fiber technology in combination with after pressing.

When using molded fiber technology, it is possible to produce lids that are made of renewable/sustainable materials which have been proven to comply with EN13432:2000 (compostability and biodegradability). In fact, when additionally using containers from a biomaterial coated paper, for instance, it is possible to provide a container, in particular for food products, in particular of the disposable type, that is fully biodegradable and compostable together and does not have to be collected in the waste bin

In an embodiment, the snap fitting allows the lid to be pushed onto the cup or beaker. It may use at least three, but preferably four or more different spots/under-cuts provided by a locally thickened part. At these thickened spots it is possible to make a small negative draft angle which is unique for snap on lid application and normally not possible in molded fiber. Number of under-cuts may be increased to five or six or more depending on the diameter of the cup and requirement of how tight fit it should provide. Accordingly, it is possible to produce a moulded fiber lid which provides a leak-tight container.

In an embodiment, ASA or AKD sizing may be used to make the fiber lids more water resistant.

In an embodiment, a hole of a certain diameter can be punched, cut or trimmed to enable the use of e.g. a spoon to mix of stir the contents like ice or liquid content of the container. As the lid is made from moulded fiber material, the cut-out part can easily be reintroduced in the production process. Thus leading to zero waste.

The height of the lid dome can be adjusted according to the end use requirement. In some embodiments, the height is about 2-4 cm. In other embodiments, a flatter or higher lid may be provided.

In an embodiment, the lid has a wall thickness of about 0.4-0.7 mm. It was even found to be possible to produce a lid with a wall thickness of about 0.35-0.60 mm. These thicknesses were measured using the Tappi T411 standard method. Using the NEN-EN-ISO 543 2005 gives almost the same results in this case. For comparison reasons, an egg carton made of moulded fiber material has a wall thickness of about 0.88 mm.

The notches are in an embodiment provided circumferentially spaced apart. Thus, they can hold the lid firmly on a container. In an embodiment, the notches extend about 0.05-0.5 mm from the remaining surface of the circumferential locking flange wall. In an embodiment, the notches extend about 0.05-0.15 mm from said surface. It was found that even such a small extension provided sufficient gripping to hold the lid on a container. For instance enough gripping was provided for holding a so-called “sip lid” onto a beaker.

In an embodiment, cutting edges may be edge coated with a polymer solution. Thus, it may be avoided that loose fibers fall into the contents, like ice cream or liquid content, of the container.

The invention further relates to an apparatus comprising one or more of the characterising features described in this description and/or shown in the attached drawings.

The invention further relates to a method comprising one or more of the characterising features described in this description and/or shown in the attached drawings.

The various aspects discussed in this patent can be combined in order to provide additional advantages. Some of the features may for part of a divisional application.

### DESCRIPTION OF THE DRAWINGS

The invention will be further elucidated referring to an embodiment of a lid according to the invention shown in the attached drawings, showing in:

FIG. 1 a perspective view of a lid;

FIG. 2 a cross sectional side view of FIG. 1;

FIG. 3 a view in the lids of FIG. 1;

FIG. 4 the lid of FIG. 1 on a container;

FIG. 5 a detail on a perspective view of a vacuum die wear ring;

FIG. 6 a cross section through part of FIG. 5.

### DETAILED DESCRIPTION OF EMBODIMENTS

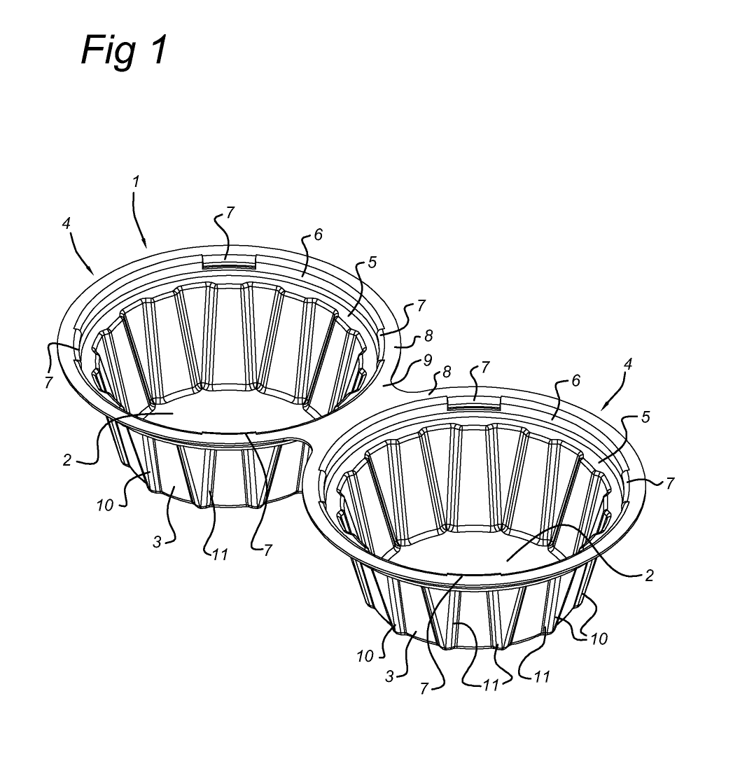

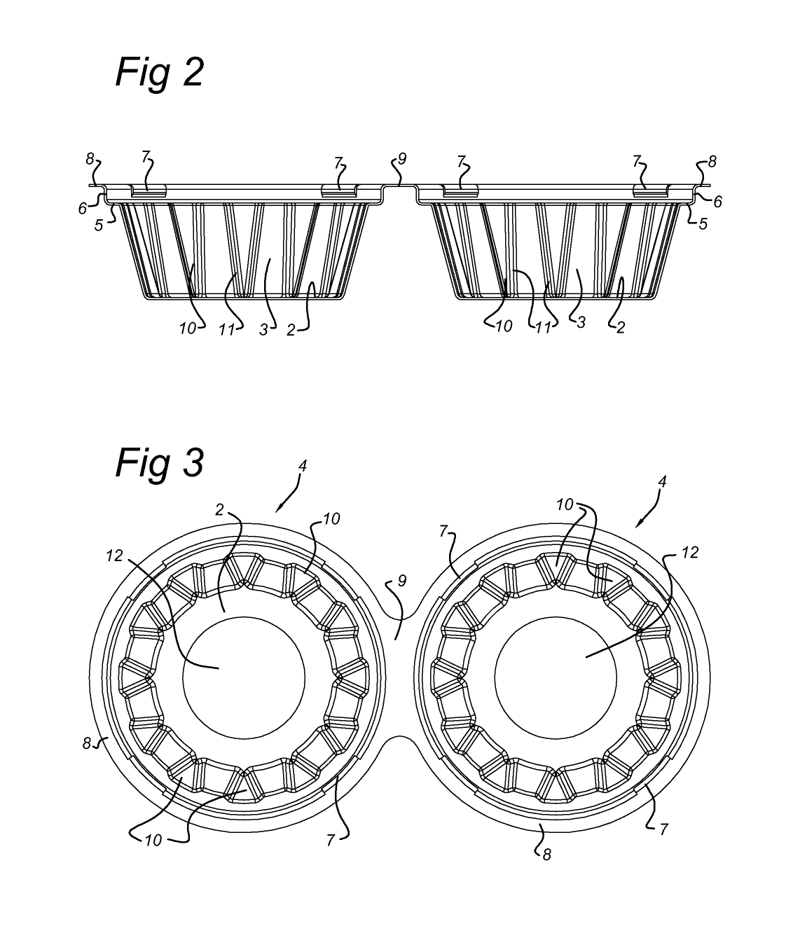

In FIG. 1, a two lids 1 are shown. These lids are connected via a bridge part. In this example, two lids are produced in one moulding step, in practise it may be possible to produce several connected lids 1. In this embodiment, lid 1 is circular or round. Other shapes like elliptic may be possible. Most cup and bakers, however, are round.

The lids 1 comprise a top wall 2 and a circumferential wall 3 connected to the top wall 2. The circumferential wall 3 in this embodiment is substantially conical. Thus improves the strength. Furthermore, the circumferential wall 3 is slightly curved in inward direction. In combination with flange 4, it provides additional strength. The strength is even further increased by adding substantially conical buttresses 10 to the circumferential wall 3. These buttresses have a wall part and a smooth transition to the connecting wall parts. Together, they form the circumferential wall 3. It was found that the construction provided so much strength that it is possible to press hard on the top wall 2 and sill leave the lid intact.

Flange 4 has several functional parts. It comprises a circumferential flange wall part 5 which extends outward from circumferential wall 3 to allow the lid to rest on top of the rim of a container. It further comprises a circumferential locking flange 6. This locking flange runs from the flange wall part 5 down. Its perimeter is adapted to fit around a rim of a container. In order to provided additional stiffness, flange 4 further comprises an outward reaching flange rim 8. This flange rim 8 runs from locking flange 6 outward.

In order to allow the lid to be snapped onto a rim of a container, the locking flange 6 comprises several notches 7 at its inner perimeter or surface. These notches 7 are massive. In order to provide a better sealing of the container, they are provided with a negative draft angle. This means that an undercut is created. This, when properly adapted to the rim of a container, may allow a liquid-tight sealing. In most cases, the rim of the container is folded outward and sometimes even curved outward. The height of the notches 7 can be a little smaller than the height of the rim part, thus pulling the lid tightly on the container. The inner perimeter of the locking flange 6 with notches 7 is often chosen a little smaller than the outer perimeter of the container, thus providing a better sealing of locking.

In production, the flange rim 8 will extend a little further than needed, and it may comprise a bridging part 9 connecting a lid 1 to a next lid. In fact, in a similar way several lids may be interconnected. After production, the lids can be separated by punching them out, decreasing the width of the flange rim 8. In order to avoid free fiber ends, the cut edge may be treated with a polymer solution, which as such is known in the art.

The top wall 2 may comprise a cut-out part 12, indicated with dotted lines in FIG. 3. This cut-out part and parts of the flange rim 8 can be returned in the pulp without causing waste.

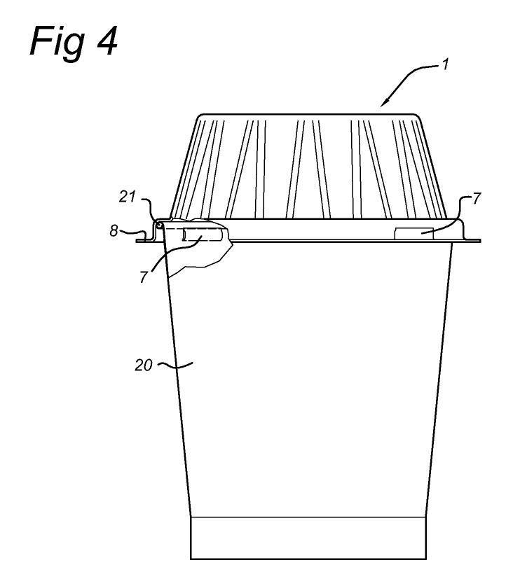

FIG. 4 shows a lid 1 on top of a container 20. The container has a circumferential container wall 20 with a rim 21 of the type well known in the art. Often, the container is of the disposable type often used for drinks, beverages, milkshakes, or ice-cream. The notches 7 described above snap around the rim as indicated. In FIG. 4, it seems as if the notches 7 are depressions which are visible form the outside. This is actually not the case. Notches 7 are solid notches. The outside wall is smooth, and the notches 7 extend inwardly and lock snappingly behind rim 21. The negative draft angle mentioned before means that in a downward direction, the notches 7 extend further from the surface of locking flange 6. Thus, notches 7 pull the lid 1 on the cup or beaker 20.

In an embodiment, the lid is produced using a pulp moulding process which is known as smooth moulding. In this process, a pulp slurry is produced which is suitable for moulding. The slurry is brought in a container from which it is moulded. To that end, one or more suction moulds are brought into the slurry container. Next, one or more lids are moulded. Slurry is sucked onto the suction moulds. These suction moulds are often of a gauze material. Fibres of the slurry are sucked onto the suction mould. The mould or moulds are subsequently rotated out of the slurry. The lid or lids produced on the moulds are then pressed onto hot vacuum moulds. After this, the suction moulds rotate back into the slurry for making one or more lids.

On the vacuum mould, the wet products are pressed at a high pressure. The lid or lid dry to a product dryness of 95%, i.e., the water contents will be about 5% by weight or less. Using hot moulds and pressure, it is possible to obtain a smooth product. The dried product is subsequently blown off the vacuum moulds and stacked. It was found possible to produce a lid with a weight of less than 4.0 gr. In fact, a weight of less that 3.5 gr was found possible for the single lid shown in FIG. 1. In practise, the centre part of the top wall 2 can be removed before use (FIG. 3) or, in case of a drinking cup lid, small parts of a drinking spout. When the lid is made of molded fiber material, these removed parts do not lead to additional waste, but can be reused in the production process.

The notches 7 need some specific technique, as usually so called undercut regions or regions which have a negative draft angle were thought to be impossible to produce as they do not come off of the mould, or cause problems in high speed production processes. Especially for notches which are circumferentially spaced apart, this was thought to pose problems.

Making the notches was found possible in the following way. The die on which the pulp is to be pressed was provided with undercuts. When the vacuum die is inserted into the pulp, it collects about 1.9-2.1 mm of pulp on its surface. The pulp will also fill the undercut regions which will form the notches. Next, the pulp will be pressed. When pressing, water will evade through the gauze of the vacuum die. In this way, it was found that additional fibre material would collect in the undercuts. Next, the pre-pressed pulp layer is hot pressed, thus further drying the fibre material, while leaving the undercut space at least partly filled with fibre material. The fibre material in the undercut will be pressed a little less than the remaining lid. Thus, the material of the notches will be a little more compressible than the remaining lid. After pressing, it will be possible to remove the lid from the die with undercut, despite the fact that the lid in fact has a negative draft angle with respect to the die.

It may even be possible to produced so called ‘sip lids’ using the current lid design of the current invention. The known ‘sip lids’ are made of plastic and have a drinking spout near an edge of the lid. In such an embodiment, circumferential wall 3 usually is less high, i.e. mostly 5-15 mm. In an embodiment, it does not have the buttresses 10.

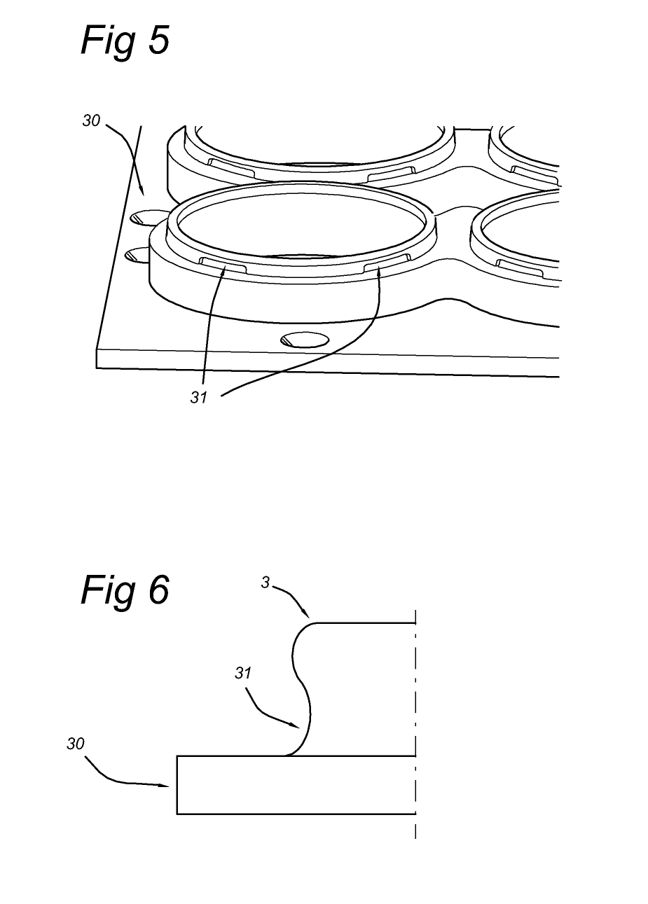

In FIG. 5, a vacuum die wear ring 30 is shown which can be used in the production of the hot-pressed, moulded fibre lid. The die ring corresponds to commonly used die rings, but in this embodiment undercuts 31 were machined in the rings which correspond to the locking flange 6 and flange rim 8. In production, it was found that first the vacuum die collects about 2 mm of pulp. Next, the die rings and further mould can be compressed to about 0.7-0.8 mm and often less. The machined cut away cavities fill with fibre pulp which also remains there during pressing. It was found that it was possible to remove the lid from the ring after compressing, and that the notches resulting from the undercuts in the vacuum die ring remain on the lid. In FIG. 6 a detail of a cross section is shown. It can be seen that the cavities are in fact are very shallow, and in fact a trade off between allowing remoal or the produced lid, and providing proper and sufficient snapping of the lid on a container. In this embodiment, the walls of the cavities have rounded edges. In fact, the edges are often more rounded than indicated in the FIG. 5. The edges have can have a rounding as indicated in the cross section shown in FIG. 6. This allows better removal of the lid in mass production.

It will also be clear that the above description and drawings are included to illustrate some embodiments of the invention, and not to limit the scope of protection. Starting from this disclosure, many more embodiments will be evident to a skilled person which are within the scope of protection and the essence of this invention and which are obvious combinations of prior art techniques and the disclosure of this patent.

1. A lid for placement on a container, said lid comprising a top wall and a circumferential wall extending downwardly from said top wall, said circumferential wall ending in a flange, said flange comprising a circumferential wall part extending outwardly from said circumferential wall for resting on an upper rim of said container and a circumferential locking wall extending downwardly from said wall part for encircling the upper rim of said container, said locking wall comprising at least two solid notches for snappingly attaching said lid around said upper rim of said container, and wherein said lid is made from hot-pressed moulded fibre material.

2. The lid according to claim 1, wherein said circumferential wall is substantially conical.

3. The lid according to claim 2, wherein said circumferential wall is curved inwardly.

4. The lid according to one of the preceding claims, wherein said circumferential wall comprises substantially conical buttresses.

5. The lid according to one of the preceding claims, wherein said flange further comprises a circumferential rim extending outwardly from said locking wall.

6. The lid according to one of the preceding claims, wherein the moulded fibre material comprises additives selected from the group consisting of AKD and ASA.

7. The lid according to one of the preceding claims, wherein said lid is produced using a smooth moulded fibre moulding process, said process comprising the steps of suction moulding at least one lid producing a wet moulded lid, bringing said wet moulded lid on a vacuum mould and hot-pressing said wet moulded lid.

8. The lid according to one of the preceding claims, wherein edges of the lid are treated with a polymer solution for avoiding free fibre ends coming off of the edges.

9. The lid according to one of the preceding claims, wherein said top wall comprises a through hole.

10. The lid according to one of the preceding claims, wherein said locking wall comprises several, in an embodiment at least four, notches, in an embodiment said notched are solid notched.

11. The lid according to one of the preceding claims, wherein said notches have a small negative draft angle providing an undercut.

12. The lid according to one of the preceding claims, wherein said notches are circumferentially spaced apart.

13. The lid according to one of the preceding claims, wherein said notches extend about 0.05-0.5 mm from an inner surface of said locking wall, in an embodiment about 0.05-0.15 mm from said inner surface.

14. A container comprising a container part having a bottom wall and a circumferential sidewall connected to said bottom wall having a rim, and a lid according to the preceding claims snap fitted on said rim.

15. Method for producing a lid according to claims 1 to 11, comprising the steps of suction moulding at least one lid producing a wet moulded lid, bringing said wet moulded lid on a vacuum mould and hot-pressing said wet moulded lid.
